(19) United States
(12) Patent Application Publication
(10) Pub. No.: US 2015/0129505 A1
(43) Pub. Date: May 14, 2015

(54) LIQUID ABSORBENT

(71) Applicant: Sokerol Group Limited, Isle of man, British Isles (GB)

(72) Inventor: John Potts Affleck, Queensland (AU)

(73) Assignee: Sokerol Group Limited, Isle Of Man, British Isles (GB)

(21) Appl. No.: 14/367,932

(22) PCT Filed: Dec. 17, 2012
(86) PCT No.: PCT/GB2012/053158

§ 371 Date: Jun. 22, 2014

Related U.S. Application Data
(60) Provisional application No. 61/579,864, filed on Dec. 23, 2011.

(51) Int. Cl. B01J 20/30; B02C 23/10; C09K 3/32; B01J 20/28; C02F 1/28; B01J 20/24

(52) U.S. Cl. CPC B01J 20/3021; C02F 1/286; B01J 20/24; C09K 3/32; B01J 20/28016; B02C 23/10
USPC 210/691; 502/401; 252/180; 241/24.1; 428/402

(57) ABSTRACT

An oleophilic product for absorbing and retaining a hydrophobic liquid such as oil. The product comprises cones of the plant species Pinus elliottii comminuted to a mixture of particles. A method of manufacturing the product is also disclosed, as is a method of absorbing and retaining a hydrophobic liquid using the product.

### FIELD OF THE INVENTION

The present invention relates to oleophilic products for absorbing and retaining hydrophobic liquids. In one particular aspect, the invention relates to a product for absorbing hydrocarbons and it will be convenient hereinafter to describe the invention in relation to that application. It should be noted, however, that the invention is not limited to that application only.

Products according to the invention comprise comminuted cones of the plant species Pinus elliottii. The invention also relates to a method of absorbing hydrophobic liquids using the products, and to a method of manufacturing the products.

### BACKGROUND OF THE INVENTION

The problem of pollution by petrochemicals such as hydrocarbons and other liquid pollutants is an ongoing and integral part of our modern existence. Petrochemicals are generally immiscible with our most useful solvent, water, and often must be rendered water miscible by the action of surface-active agents such as detergents and dispersants before water can be used as the bulk dispersal medium.

In situations where oil decontamination of hard surfaces is required, solutions have generally revolved around the use of dispersants, detergents or saponifying chemicals, again to render the contaminants water-dispersable for disposal by volumetric flushing with water. The obvious problems associated with dispersant technology reside in its fundamental mode of operation: it does not remove the contaminant from the contaminated medium.

Dispersants are equally problematic where decontamination of oil on water is required, for example after an ocean oil spill. Although the capacity of the ocean to deal with the dispersed contaminant is remarkable, by the time the contaminant is degraded considerable economic and ecological damage may be done, particularly to filter feeding species such as shell fish, subsequent to the initial disruption to fish and birds.

The use of absorbents for removal of oily contaminants has been contemplated in the past, with several remedies proposed with varying degrees of success.

The use of oil-swellable polymer beads has been considered. However, the sheer volume of the more serious contamination incidents and the ongoing requirements of industries which generate large volumes of contaminants have, in combination with the cost of the beads, made the proposal unworkable from an economic view point.

Cheaper particulates, especially sawdust have been satisfactorily used for small scale removal of liquid contaminants such as oil from solid surfaces. However, volumetric performance is extremely poor, and performance in aqueous environments is totally inadequate. Such products also have an inherently high water content, and the dried product rapidly absorbs atmospheric water resulting in storage, handling and safety problems including caking and especially spontaneous combustion due to exothermic decomposition. Furthermore, sawdust has an inherent tendency to desorb or leach the contaminant when it becomes saturated with the contaminant and the concentration of surrounding contaminant has been reduced or eliminated.

Use of comminuted cones of coniferous trees to absorb hydrophobic liquids has also been proposed, with the species Pinus radiata preferred. However, there remains room for improvement in absorption and retention of such liquids.

It is therefore an object of the present invention to provide an absorbent for hydrophobic liquids which does not suffer from the disadvantage of the aforementioned products and has improved absorption and/or retention of liquids.

### SUMMARY OF THE INVENTION

The present invention arises from a discovery that comminuting cones of the plant species Pinus elliottii provides a surprisingly absorbent product. The product may be used, for example, to absorb oil on land or at sea.

In a first aspect, the invention provides an oleophilic product for absorbing and retaining a hydrophobic liquid. The product comprises cones of Pinus elliottii comminuted to a mixture of particles.

The liquid is preferably a petrochemical, and most preferably a hydrocarbon such as oil.

The mixture comprises preferably about 15 to 50%, more preferably about 20 to 30%, by weight of particles less than about 1 mm in length and preferably about 50 to 85%, more preferably about 65 to 80%, by weight of particles between about 1 and 3 mm in length, based on the total weight of the mixture. Preferably, the mixture includes less than 1% by weight of particles less than 10 microns in length, more preferably less than 0.1% by weight of particles less than 10 microns in length. The mixture preferably includes less than 5% by weight of particles less than 75 microns in length and less than 15% by weight of particles less than 100 microns in length. Particles less than 100 microns are considered inspirable.

Generally, the bulk density will fall within the range of 0.1 to 0.5 kilograms per litre (kg/L). The bulk density of the product is preferably between 0.2 and 0.4 kg/L, more preferably about 0.2 kg/L. The bulk density can be varied depending on the nature of the hydrophobic liquid to be absorbed. For highly viscous liquids such as oils, the bulk density will usually be lower, whereas for low viscosity liquids, the bulk density will usually be higher.

In a second aspect, the invention provides a method of absorbing and retaining a hydrophobic liquid. The method comprises contacting the liquid with an effective amount of the product of the first aspect of the invention.

The hydrophobic liquid is preferably a petrochemical, and more preferably a hydrocarbon such as oil.

Every 1 kg of the product preferably absorbs approximately 1.5 L of a petrochemical liquid. Where the hydrophobic liquid is absorbed from the surface of an immiscible heavier liquid such as water, the amount of product used is preferably sufficient to cover the hydrophobic liquid with a layer which is twice the thickness of the oil layer. Surprisingly, if product according to the invention is saturated with water and subsequently contacted with a hydrophobic liquid, the product will effectively eject the water in favour of the hydrophobic liquid.

Preferably, for every L of oil absorbed by the product, less than 10 mg of oil leaches out, when measured according to the Total Characteristic Leaching Procedure set out in Example 3.

In a third aspect, the invention provides a method of manufacturing the product of the first aspect of the invention. The method of manufacturing comprises:

comminuting dry cones of Pinus elliottii to form particles; and

sieving the comminuted particles.

The comminuting and sieving steps may be performed separately, in sequence, or may be performed simultaneously in a single processing machine, such as a hammer mill having within it a sieve of a desired size. The product may also be subject to dual sieving having an initial sieving followed by a secondary independent sieving to separate finer particles for special purpose applications.

The method of manufacturing may also comprise deseeding the cones prior to comminution and/or removing respirable and/or inspirable particles after sieving.

### DETAILED DESCRIPTION OF THE INVENTION

Before proceeding to describe the present invention in more detail, it is important to note that various terms that will be used throughout the specification have meanings that will be well understood by the skilled addressee. For ease of reference, some of these terms will now be defined.

The term ‘oleophilic’ means having a strong affinity for oils (in preference to water).

The term ‘absorb’ as used herein means to take up or receive, and includes to ‘adsorb’. When used in the context of the product of the present invention, ‘absorbing’ encompasses both incorporating the liquid into the product and physically adhering or bonding molecules and/or ions onto a surface of the product (sometimes referred to as ‘adsorbing’). The terms ‘absorption’ and ‘absorbent’ have corresponding meanings.

The term ‘retain’ as used in the context of the product of the present invention means that the product does not leach or desorb a significant amount of absorbed liquid. More than about 50 mg/L of the hydrophobic liquid is a significant amount of liquid, when measured according to the Toxic Characteristic Leaching Procedure (TCLP) set out under Example 3.

The term ‘hydrophobic’ as used herein simply means water-repelling. Hydrophobic liquids are generally non-polar and include, for example, hydrocarbons such as oils, as well as vegetable oils and animal fats.

The term ‘comminute’ as used herein means to reduce to fibre and/or particulate form, for example by pulverising or triturating.

The term ‘inspirable dust particles’ as used herein means particles which tend to lodge in the human upper respiratory tract. Inspirable dust particles generally correspond to particles less than 100 microns in length.

The term ‘respirable dust particles’ means particles which tend to lodge in the human lungs. Respirable dust particles generally correspond to particles less than 10 microns in length.

Particle size is described in terms of length. The length of a particle refers to the size of its longest dimension. Where a particle is of equal size across two or three dimensions, the term ‘length’ refers to that size. Hence where a particle is spherical in shape, the term ‘length’ refers to its diameter.

Unless specifically indicated otherwise, particle size distributions within a product mixture are described herein with reference to percentages measured by weight relative to the total weight of the mixture.

The present invention uses cones of the plant species Pinus elliottii. Pinus elliottii is also known as Pinus densa, Pinus caribaea Morelet and Pinus Heterophylla. The plant species is commonly known as Slash Pine. Other common names include slash pine, yellow slash pine, swamp pine, pitch pine, South Florida slash pine, Dade County slash pine, Dade County pine and Cuban pine.

Varieties of Pinus elliottii suitable for use in the present invention include both P elliottii var elliottii and P elliottii var densa.

The present invention provides a product for absorbing a liquid. The product comprises cones of Pinus elliottii comminuted to a mixture of particles.

Products produced according to the present invention may be produced organically and are biodegradable and ecologically sustainable.

Products according to the invention may be used on land and water. On land, the products may be used to absorb hydrophobic liquids from solid surfaces such as roads. They may also be used to absorb hydrophobic liquids on liquid surfaces, such as oil spills at sea.

In use, the product need only be in contact with the liquid for a short period of time. The product may be dispersed freely over a contaminated area, or contained in nets or containers to make retrieval of the spent product easier.

In addition to hydrocarbon spills, liquids which may be absorbed by products of the invention include cooking oils, bitumen, agricultural chemicals, pesticide, resins, acetone, paint and thinners.

The product is preferably manufactured from dry cones.

The cones are best harvested or collected when dry. Wet cones have a tendency to be closed, gripping unwanted secondary materials such as needles or gravel. Such secondary materials can reduce product effectiveness and/or increase wear and tear on processing machinery. The cones preferably have all needles removed. This reduces the chances of processing machinery blockage.

The product can also be manufactured from cones which are harvested wet, and subsequently dried. The cones may be dried either naturally or artificially, such as in a kiln or drying room. Any suitable drying process can be used. In any event, the resulting moisture content of the dried cones is preferably between about 1% and 5%. The cones may also be deseeded and, in this regard, drying the cones in a kiln helps to open the cones for seed extraction.

The cones may be comminuted by milling in a hammer mill which includes a modified sieve that the cones are forced through. Sieve hole diameters of between approximately 6 and 12 mm are preferred, with a spacing of between 8 and 12 mm between holes. More preferably, the sieve hole diameter is approximately 8 mm, and the holes are spaced at 10 mm intervals. The resulting percentages by weight of particle size are generally 25% less than 1 mm and 75% between 1 and 3 mm. Particles larger than 3 mm (possibly in the range of 4-6 mm) may occur in small percentages but the goal, at least in this example, is for all particles to be less than 3 mm. Sieve hole size and layout can be varied to maximise product performance based on cone size and shape, humidity and cone moisture content.

The product thus prepared is ready for immediate use. It may, however, be subject to subsequent processing, for example removing respirable and/or inspirable dust particles to improve safe handling. Other subsequent processing may include the addition of fire retardants, extenders, dyes and the like.

A preferred apparatus for generating the comminuted cone product includes a drying area for drying wet cones. A conveyor is used to carry dry cones to a hammer mill. The hammer mill or other comminuting device breaks the cones down to individual fractured pieces. The individual fractured pieces are then forced through a sieve by the hammer mill to ensure preferred size ranges are achieved. Alternatively, or in addition, a separate sieve could also be used to remove particles which are unsuitably large, for example greater than 3 mm in the example above. Centrifugal fans can be used to extract unwanted dust particles. Sieved particles may be transferred via an auger. The material may be dispensed in bulk, or packaged, for example with a bagging machine.

A preferred absorbent product according to the present invention has the following physical parameters:

a fibrous and particulate mixture;

approximately 25% by weight of particles less than 1 mm in length;

approximately 75% by weight of particles between 1 mm and 3 mm in length;

less than 0.1% by weight of particles less than 10 microns in length (respirable dust particles);

less than 15% by weight of particles less than 100 microns in length (insiprable dust particles);

bulk density between 0.2 and 0.4 kg/L, preferably 0.3 kg/L;

specific gravity of 1.6; and

moisture content less than 5%.

Respirable and inspirable dust particles are preferably minimised for health, safety and comfort of the user.

Particle size affects product handling and the ability of the product to retain the hydrophobic liquid. Optimal particle size optimises ease of:

use (including product weight, ability to mat together on water surface for ease of recovery;

disposal, with minimal liquid leaching; and

speed of absorption. Smaller particle size increases surface area which generally increases the rate of absorption of the hydrophobic liquid.

The preferred absorbent product mentioned above may, in one form, be packaged for the consumer market within a waste disposal receptacle intended for fats, oils and greases (FOGs). Such a FOG disposal receptacle, or FOG Trap, may then be used within households, small businesses, commercial and industrial premises, or recreational venues (such as places for motorsport or boating), for safe capture and environmentally responsible disposal of waste FOGs such as leftover cooking oil and used engine oils. The preferred form of such a receptacle is essentially a container, partly filled with the product. Within the container, above the product, is a collector insert for holding a measure volume of the FOGs. The collector includes means (such as perforations) for regulating the flow of the FOGs initially held in the collector to the absorbent product in the lower portion of the container. The FOG Trap also has a lid to contain the absorbent product during shipping and to seal the container once used.

To use the FOG Trap, the user removes the lid, pours eg., waste cooking oil into the collector insert where it then flows through into the absorbent product below. Once the absorbent capacity of the product is maximized, the user replaces the lid and the entire package can be disposed of without any concern of the waste harming the environment as the packaging is all biodegradable bagasse, the absorbent product is organic and the contaminant is encapsulated within the absorbent product where it is rendered inert while biodegrading along with the absorbent product it is contained within.

In this example application, the absorbent product is primarily made up of particles smaller than 3 mm.

Examples of materials and methods for use with the compositions and methods of the present invention will now be provided. In providing these examples, it is to be understood that the specific nature of the following description is not to limit the generality of the above description.

### EXAMPLE 1

### Manufacture

Cones of Pinus elliottii were dried. The dried cones were milled in a hammer mill incorporating a sieve with 8mm holes and 10 mm spacing between holes, and was then subjected to further independent sieving. Lighter (dust) particles were extracted. Most respirable dust particles (less than 5 microns) were removed and inspirable dust was reduced to below 15%.

The resulting product was made up of about 25 to 30% by weight of particles less than about 1 mm in length and about 70 to 75% by weight of particles between about 1 and 3 mm in length.

### EXAMPLE 2

### Comparative Oil Absorption

A batch of product was prepared according to the method of Example 1, using cones of Pinus elliottii. A comparative batch was also prepared according to the method of Example 1, but the Pinus elliottii cones were substituted with Pinus radiata cones.

The oil sorption test was based on ASTM International's Standard Method of Testing Sorbent Performance of Adsorbents. A sieved (>1 mm), dry 250 g sample of the Pinus radiata batch was weighed and placed into a second metal sieve with a 3 mm sieve size. A sieved (>1 mm), dry 250 g sample of the Pinus elliottii was also weighed and placed into a second metal sieve with a 3 mm sieve size. The sieves containing the samples of Pinus radiata and Pinus elliottii were placed into 12 L plastic trays. Shell 20 W/50 motor oil was then poured into each tray until the samples in each sieve was submerged. After remaining submerged in motor oil for a period of 15 min, each sample was removed and allowed to drain for 2 min. After draining, each sample was weighed.

In the present example, particles less than 1 mm were removed so that particles were not lost during the draining process. Particles less than 1 mm may generally be retained in products according to the invention. Such particles increase absorbency by both volume and speed.

TABLE 1
OIL ABSORPTION RATIO

| Parameter | Units | Pinus radiata | Pinus elliottii |
|---|---|---|---|
| Pick-up Ratio | (g oil/g absorbent) | 0.9 | 1.5 |

The Pinus elliottii sample absorbed more than 60% more oil than the Pinus radiata sample.

### EXAMPLE 3

### Toxic Characteristic Leaching

Each of the drained samples of Example 2 was subjected to the following Toxic Characteristic Leaching Procedure (TCLP). The procedure is based on USEPA test method 1311, referenced in Australian Standard 4439.3-1997.

The sample was placed in a mechanical separator rotating at 30 rpm for 18 h. The resulting separated solution was subjected to liquid-liquid extraction using n-hexane as solvent. The extracted (leached') compounds were measured using gas chromatography/mass spectrometry. The total petroleum hydrocarbon (‘TPH’) mass was measured for fractions having including between 6 and 36 carbon atoms.

The results are shown in Table 2. The ‘Parameter’ column lists the fractions measured, by increasing molecular weight. For example, ‘TPH C₆-C₉’ indicates total petroleum hydrocarbons having a carbon ‘backbone’ of between 6 and 9 carbon atoms in length. The amount of each hydrocarbon fraction leached out is tabulated, in μg of the hydrocarbon fraction per L of oil absorbed. The results for the TPH C₆-C₉ string are less consequential as they correspond to light fuels which readily evaporate.

TABLE 2
LEACHATE TEST

| Parameter | Units | Pinus radiata | Pinus elliottii |
|---|---|---|---|
| TPH C₆-C₉ | μg/L | 74.0 | 92.0 |
| TPH C₁₀-C₁₄ | μg/L | 330 | 240 |
| TPH C₁₅-C₂₈ | μg/L | 2400 | 2300 |
| TPH C₃₀-C₃₆ | μg/L | 2600 | 1700 |
| Total Petroleum | mg/L | 5 | 4 |
| Hydrocarbons | | | |

Table 2 also lists the total petroleum hydrocarbons leached, in mg of the hydrocarbon fraction per L of oil absorbed. For every L of oil that the Pinus elliottii sample absorbed, only 4 mg leached out, and for every L of oil that the Pinus radiata sample absorbed, 5 mg leached out. These results show that samples were effectively non-leaching.

The Australian Standard for the disposal of liquid industrial waste sets the following leaching levels for hydrocarbons (oils/fuels) in municipal landfill:

unlined landfill: less than 25 mg/L; and

lined landfill: less than 50 mg/L.

The tested leaching levels are well within the levels set in the Australian Standard.

Table 3 shows the amount of each hydrocarbon fraction leached out per g of oil absorbed. Totals are also shown for the amount of oil leached out per g of oil absorbed. These figures indicate the overall effectiveness of the samples, taking into account both:

the oil absorption ratios of Table 1; and

the leaching values of Table 2.

TABLE 3
OIL ABSORPTION AND LEACHATE COMPARISON

| Parameter | Units | Pinus radiata | Pinus elliottii |
|---|---|---|---|
| TPH C₆-C₉ | μg/L/g oil absorbed | 81 | 63 |
| TPH C₁₀-C₁₄ | μg/L/g oil absorbed | 360 | 166 |
| TPH C₁₅-C₂₈ | μg/L/g oil absorbed | 2615 | 1587 |
| TPH C₃₀-C₃₆ | μg/L/g oil absorbed | 2833 | 1173 |
| Total Petroleum | mg/L/g oil absorbed | 6 | 3 |
| Hydrocarbons | | | |

The totals shown in the bottom row indicate that for the purpose of absorbing oil, the Pinus elliottii sample (3 mg/L/g) was twice as effective as the Pinus radiata sample (6 mg/L/g). The Pinus elliottii sample was more effective, in terms of its ability to absorb and retain oil.

Finally, it will be appreciated that various modifications and variations of the methods and compositions of the invention described herein will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that are apparent to those skilled in the art are intended to be within the scope of the appended claims.

1. An oleophilic product for absorbing and retaining a hydrophobic liquid, the product comprising cones of the plant species Pinus elliottii comminuted to a mixture of particles.

2. The product of claim 1, wherein the mixture comprises about 15 to 50% by weight of particles less than about 1 mm in length and about 50 to 85% by weight of particles between about 1 and 3 mm in length, based on the total weight of the mixture.

3. The product of claim 2, wherein the mixture comprises about 20 to 30% by weight of particles less than about 1 mm in length and about 65 to 80% by weight of particles between about 1 and 3 mm in length.

4. The product of claim 3, wherein the mixture includes less than 1% by weight of particles less than 10 microns in length, less than 5% by weight of particles less than 75 microns in length and less than 15% by weight of particles less than 100 microns in length.

5. The product of claim 4, wherein the mixture includes less than 0.1% by weight of particles less than 10 microns in length.

6. The product of claim 1, wherein the bulk density is between 0.2 and 0.4 kg/L.

7. The product of claim 6, wherein the bulk density is about 0.2 kg/L.

8. The product of claim 1, wherein the hydrophobic liquid is a hydrocarbon, vegetable oil or animal fat.

9. A method of absorbing and retaining a hydrophobic liquid, comprising contacting the liquid with an effective amount of the product of claim 1.

10. The method of claim 9 wherein the hydrophobic liquid is a petrochemical.

11. The method of claim 10, wherein every 1 kg of the product absorbs at least 1.5 L of the petrochemical.

12. The method of claim 9, wherein, for every L of hydrophobic liquid absorbed by the product, less than 10 mg of hydrophobic liquid leaches out, when measured according to the Total Characteristic Leaching Procedure set out in Example 3.

13. The method of claim 9, wherein the hydrophobic liquid is absorbed from the surface of a hydrophilic liquid and the effective amount of the product is sufficient product to cover the hydrophobic liquid with a layer which is twice the thickness of the oil layer.

14. A method of manufacturing an oleophilic product for absorbing and retaining a hydrophobic liquid, the method comprising:
comminuting dry cones of Pinus elliottii to form particles; and
sieving the comminuted particles.

15. The method of claim 14, wherein the comminuting step is performed using a hammer mill.

16. The method of claim 15, wherein the hammer mill includes an integral sieve which has holes with a diameter of between about 6 mm and 12 mm and a spacing of between about 8 mm and 10 mm.

17. The method of claim 16, wherein the sieve has holes with a diameter of about 8 mm and a spacing of about 10 mm.

18. The method of claim 14, further comprising drying the cones prior to comminution.

19. The method of claim 14, further comprising deseeding the cones prior to comminution.

20. The method of claim 14, further comprising removing respirable and/or inspirable dust particles after sieving.
